(19) United States
(12) Patent Application Publication
(10) Pub. No.: US 2021/0317864 A1
(43) Pub. Date: Oct. 14, 2021

(54) BOLT RETAINER CLIP TO MAINTAIN A BOLT WITHIN A CONFIGURED RECEIVING ELEMENT OF A COMPONENT

(71) Applicant: Caterpillar Inc., Peoria, IL (US)

(72) Inventors: Douglas Charles SERRURIER, Morton, IL (US); Josiah VILLARREAL, Peoria, IL (US)

(73) Assignee: Caterpillar Inc., Peoria, IL (US)

(21) Appl. No.: 16/844,800

(22) Filed: Apr. 9, 2020

(51) Int. Cl. F16B 39/28

(52) U.S. Cl. CPC F16B 39/28

(57) ABSTRACT

A bolt retainer clip, to maintain a bolt within a bolt receiving element of a component, may comprise a component clip that is configured to: be inserted within the bolt receiving element of the component, and clip onto a first surface of the component and a second surface of the component that is also a surface of the bolt receiving element. The bolt retainer clip may comprise a bolt engaging element that is configured to engage with the bolt.

### TECHNICAL FIELD

The present disclosure relates generally to a bolt retainer clip to maintain a bolt within a configured receiving element of a component.

### BACKGROUND

Ground engaging tools may be secured in place to a work implement of a machine, such as a mining machine, a construction machine, an earth moving machine, and/or the like. For example, the ground engaging tools may be secured using bolts positioned within the ground engaging tools. However, in some instances, the position of the bolts may not be completely fixed within the ground engaging tools. As a result, the bolts may be displaced during removal of the ground engaging tools from the work implement and/or during installation of the ground engaging tools on the work implement. Accordingly, one or more workers may be required to manually maintain and/or adjust the position of the bolts during removal and installation of the ground engaging tools.

Slide-fitting an air bag module with a steering wheel hub by a snap-fit connection to quickly and easily assemble the components together is disclosed in U.S. Pat. No. 5,755,458 issued to Textron Inc. (“the '458 patent”). The '458 patent discloses that the air bag module is provided with a pair of fastener members releasably attached thereto and that the steering wheel hub is provided with a pair of U-shaped holding members, each of which is formed from a spring clip member. The '458 patent further discloses that the fastener members on the air bag module slide in and securely engage the U-shaped clip members on the steering wheel hub with a snap-fit action to secure the air bag module to the steering wheel hub. The '458 patent additionally discloses that the air bag module can thereafter be released from the steering wheel hub by a qualified technician when needed for service or replacement. However, the '458 patent does not disclose that the fastener members can address the problems associated with the displacement of the bolts, as mentioned above.

The bolt retainer clip of the present disclosure solves one or more of the problems set forth above and/or other problems in the art.

### SUMMARY

According to some implementations, a bolt retainer clip, to maintain a bolt within a bolt receiving element of a component, may comprise: a component clip that is configured to: be inserted within the bolt receiving element of the component, and clip onto a first surface of the component and a second surface of the component that is also a surface of the bolt receiving element; and a bolt engaging element that is configured to engage with the bolt.

According to some implementations, a pre-installation assembly, for mechanically attaching a component to a machine implement using a bolt, may comprise: the component; and a bolt retainer clip to retain the bolt within a bolt receiving element of the component, wherein the bolt retainer clip comprises: a component clip configured to be: inserted within the bolt receiving element of the component, and clipped onto a first surface of the component and a second surface of the component that is also a surface of the bolt receiving element. The pre-installation assembly may further comprise a bolt engaging element configured to engage with the bolt.

According to some implementations, a component, configured to be attached to a machine implement via a bolt, may comprise: a bolt receiving element; and a bolt retainer clip recess associated with the bolt receiving element, wherein the bolt retainer clip recess includes: a first recess portion that is configured to receive a first portion of a component clip, and a second recess portion that is configured to receive a second portion of the component clip, wherein the component clip is a portion of a bolt retainer clip that is configured to clip onto the component to permit a bolt engaging element of the bolt retainer clip to retain the bolt within the bolt receiving element.

### BRIEF DESCRIPTION OF THE DRAWINGS

FIG. 1 is a diagram of an example machine implement to which multiple components are attached using multiple bolts.

FIG. 2 is a diagram of an example sheet of material that is used to form an example bolt retainer clip that may be used with the bolts of FIG. 1.

FIGS. 3A-3D are diagrams of different views of an example bolt retainer clip that may be used with the bolts of FIG. 1.

FIGS. 4A-4C are cross-sectional view diagrams of a component of FIG. 1 with a bolt retainer clip and a bolt of FIG. 1.

FIGS. 5A and 5B are diagrams of an example bolt retainer clip that may be used with the bolts of FIG. 1.

FIGS. 6A and 6B are diagrams of an example bolt retainer clip that may be used with the bolts of FIG. 1.

FIGS. 7A and 7B are diagrams of the bolt retainer clips of FIG. 5 and FIG. 6 being used with a component and a bolt of FIG. 1.

### DETAILED DESCRIPTION

This disclosure relates to a bolt retainer clip to maintain a bolt within a configured receiving element of a component. The bolt retainer clip has universal applicability to any machine utilizing such a bolt retainer clip. The term “machine” may refer to any machine that performs an operation associated with an industry, such as, for example, mining, construction, farming, transportation, or any other industry. As some examples, the machine may be a vehicle, a backhoe loader, a cold planer, a wheel loader, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or another above ground equipment, underground equipment, or marine equipment. Moreover, one or more implements may be connected to the machine.

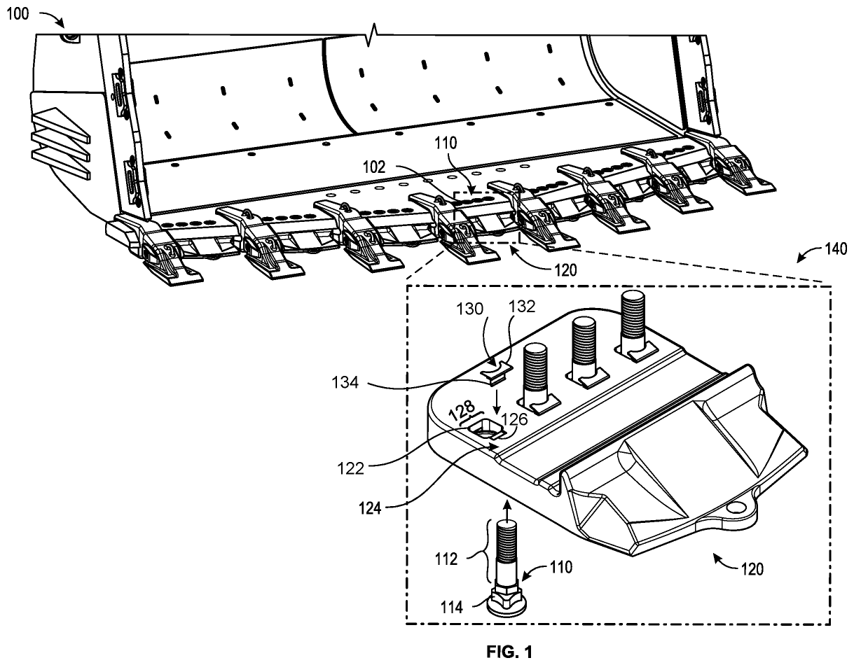

FIG. 1 is a diagram of an example machine implement to which multiple components are attached using multiple bolts. Machine implement 100 is shown in FIG. 1 as a bucket (e.g., an above ground loader bucket) but may be other types of buckets or other types of implement. As shown in FIG. 1, one or more bolts 110 secure one or more components 120 to machine implement 100. For example, each component 120 may be mechanically attached to machine implement 100 via one or more bolts 110 received through one or more machine implement holes 102.

As shown in FIG. 1, bolt 110 includes a threaded portion 112 and a shoulder 114. As shown in FIG. 1, for example, bolt 110 is a plow bolt. Alternatively, bolt 110 may include a carriage bolt or a hex head bolt. Component 120 may be configured to perform work on material. As shown in FIG. 1, for example, component 120 is a ground engaging tool, such as a ground engaging tooth. However, component 120 may be any other component that may be secured to machine implement 100. As shown in FIG. 1, component 120 includes one or more bolt receiving elements 122 that may receive one or more bolts 110 and one or more bolt retainer clips 130. Bolt receiving elements 122 may abut a first surface 124 of component 120. For example, bolt receiving elements 122 may be located on or located proximate to first surface 124. As shown in FIG. 1, first surface 124 is a top surface of component 120. As shown in FIG. 1, component 120 includes a bolt retainer clip recess 126. A bolt receiving element 122 may have a width 128.

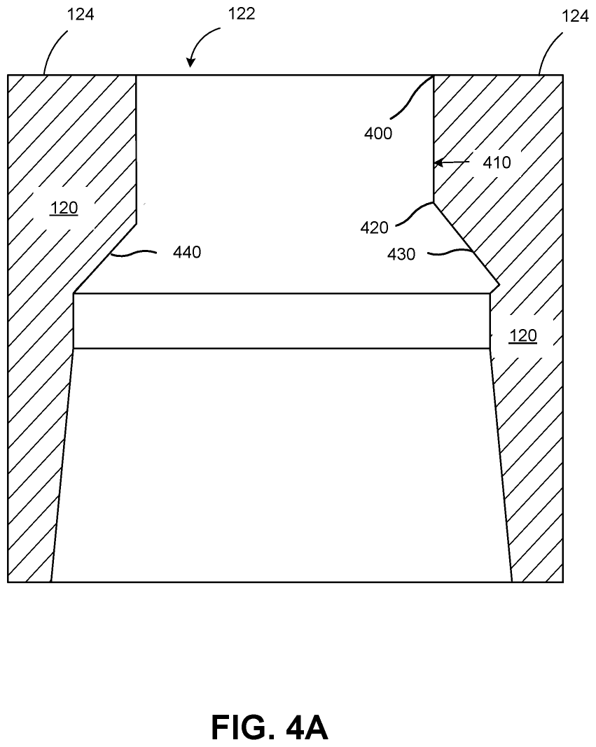

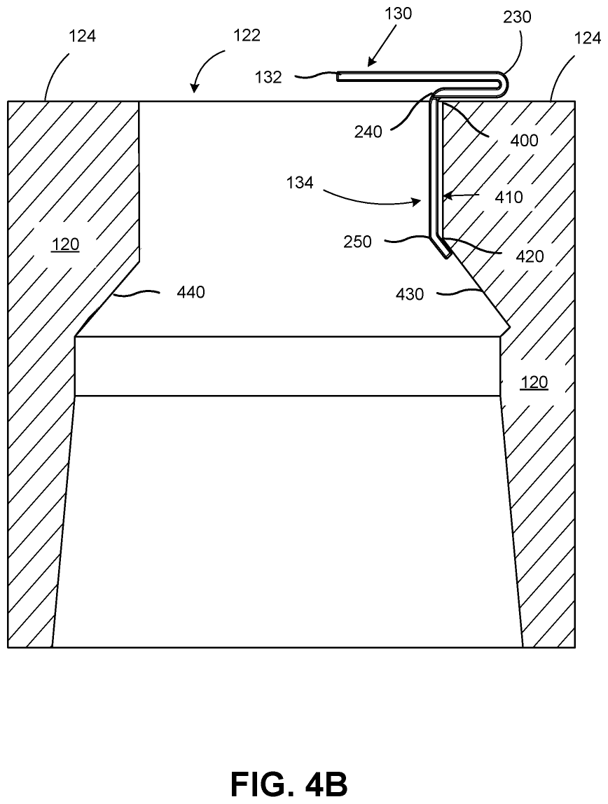

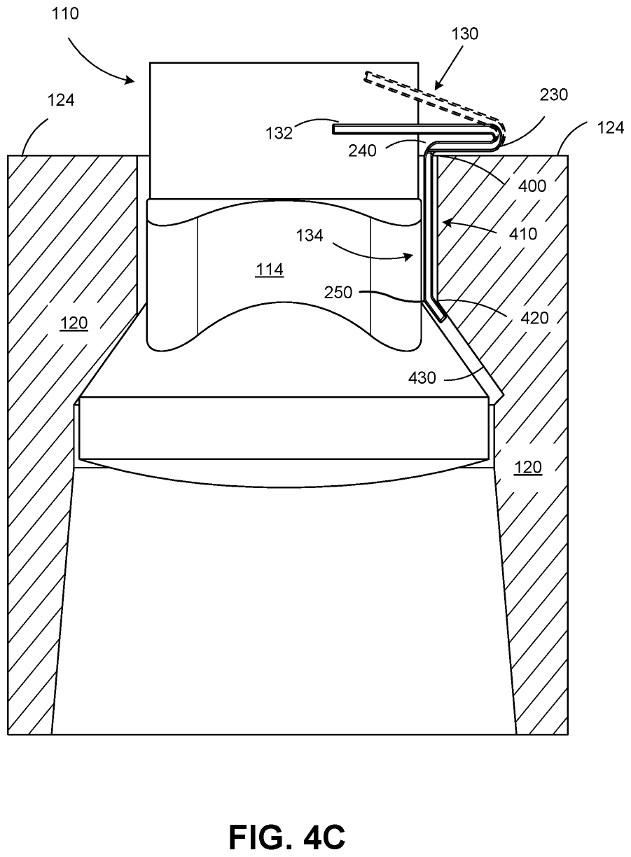

As shown in FIG. 1, bolt retainer clip 130 includes a bolt engaging element 132 and a component clip 134. Bolt engaging element 132 is configured to engage with bolt 110. Component clip 134 is inserted within bolt receiving element 122 and clips onto first surface 124 of component 120. For example, component clip 134 (or a portion of component clip 134) is inserted within bolt retainer clip recess 126 of component 120. Bolt retainer clip recess 126 of component 120 may be associated with bolt receiving element 122. For example, bolt retainer clip recess 126 of component 120 may abut a surface of bolt receiving element 122. Component clip 134 also clips onto another surface of component 120 that is also a surface of bolt receiving element 122, as will be described in more detail below with respect to FIG. 4.

As shown in FIG. 1, bolt 110 is received through bolt receiving element 122 of component 120, after bolt retainer clip 130 has been installed on bolt receiving element 122 (as explained above). In other words, bolt retainer clip 130 is configured to be inserted within bolt receiving element 122 before bolt 110 is received through bolt receiving element 122. A portion of bolt 110 may be received through bolt receiving element 122. For example, threaded portion 112 of bolt 110 may be received through bolt receiving element 122. As will be explained in more detail below with respect to FIG. 4, bolt retainer clip 130 may retain bolt 110 within bolt receiving element 122 of component 120.

As shown in FIG. 1, pre-installation system 140 includes bolts 110, component 120, and bolt retainer clips 130. Pre-installation system 140 may be an assembly for mechanically attaching component 120 to machine implement 100 using bolts 110. Bolts 110 are secured, within component 120, using bolt retainer clips 130. As will be apparent from the description herein, by retaining bolts 110 within bolt receiving element 122 using bolt retainer clips 130, bolts 110 may be maintained within bolt receiving elements 122. In this regard, bolts 110 may be maintained within bolt receiving elements 122 during installation of component 120 on machine implement 100 and during removal of component 120 from machine implement 100.

As indicated above, FIG. 1 is provided as an example. Other examples may differ from what was described in connection with FIG. 1.

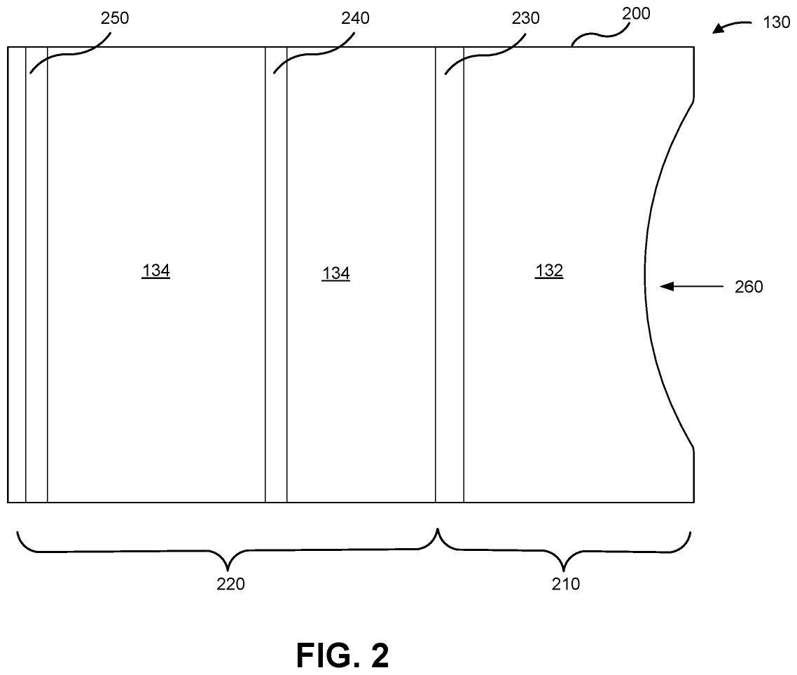

FIG. 2 is a diagram of an example sheet of material that is used to form an example bolt retainer clip that may be used with the bolts of FIG. 1. As shown in FIG. 2, bolt retainer clip 130 may be formed from a same sheet of material 200. Bolt engaging element 132 may be formed using a first portion 210 of sheet of material 200. Component clip 134 may be formed using a second portion 220 of sheet of material 200.

As shown in FIG. 2, sheet of material 200 includes bend 230, bend 240, and bend 250. Sheet of material 200 is bent along bend 230, bend 240, and bend 250 to form bolt retainer clip 130. For example, sheet of material 200 is bent at bend 230 to form first portion 210 that includes bolt engaging element 132 and form second portion 220 that includes component clip 134. As shown in FIG. 2, bend 230 is located between bolt engaging element 132 and component clip 134. As shown in FIG. 2, first portion 210 of sheet of material 200 includes a concave edge 260. A circumference of concave edge 260 may correspond to a portion of a circumference of a threaded portion (e.g., threaded portion 112) of bolt 110.

As indicated above, FIG. 2 is provided as an example. Other examples may differ from what was described in connection with FIG. 2.

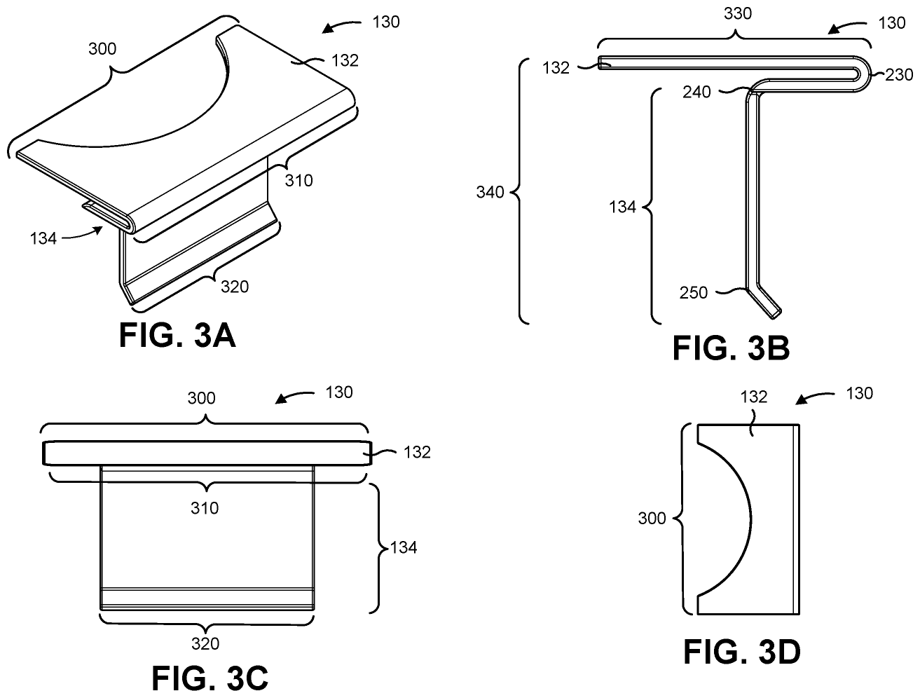

FIGS. 3A-3D are diagrams of different views of an example bolt retainer clip that may be used with the bolts of FIG. 1. FIG. 3A is a perspective view of bolt retainer clip 130. FIG. 3B is a side view of bolt retainer clip 130. FIG. 3C is a rear view of bolt retainer clip 130. FIG. 3D is a top view of bolt retainer clip 130.

As shown in FIGS. 3A, 3C, and 3D, a width 300 of bolt engaging element 132 (or bolt engaging element width 300) is wider than a diameter of thread portion 112 of bolt 110. Accordingly, bolt engaging element 132 may be able to properly engage with bolt 110. As shown in FIGS. 3A, 3C, and 3D, a width 310 of a first portion of component clip 134 (or first portion width 310) may correspond to bolt engaging element width 300. For example, first portion width 310 may be substantially equal to bolt engaging element width 300. As shown in FIGS. 3A, 3C, and 3D, a width 320 of a second portion of component clip 134 (or second portion width 320) may correspond to width 128 of bolt receiving element 122. For example, second portion width 320 may be substantially equal to width 128.

As shown in FIG. 3B, a length 330 of bolt engaging element 132 may exceed a length of bolt retainer clip recess 126 of component 120. A height 340 of bolt retainer clip 130 may exceed a depth of bolt receiving element 122. Accordingly, bolt retainer clip 130 may be fully inserted within bolt receiving element 122.

In some implementations, dimensions of bolt retainer clip 130 may be context dependent. For example, dimensions of bolt retainer clip 130 may vary based on a type, size, and/or configuration of component 120 and/or bolt 110.

As indicated above, FIGS. 3A-3D are provided as examples. Other examples may differ from what was described in connection with FIGS. 3A-3D.

FIGS. 4A-4C are cross-sectional view diagrams of a component of FIG. 1 with a bolt retainer clip and a bolt of FIG. 1. As shown in FIG. 4, bolt receiving element 122 of component 120 includes a top edge 400, an inner surface 410, and an interior edge 420. Component 120 includes a surface (e.g., a second surface 430) and a surface 440. As shown in FIG. 4A, top edge 400 is located between inner surface 410 of bolt receiving element 122 and first surface 124 of component 120. Interior edge 420 is located between inner surface 410 of bolt receiving element 122 and second surface 430 of component 120. Inner surface 410 is located between first surface 124 and second surface 430 of component 120. Second surface 430 may correspond to an interior surface of component 120.

As shown in FIGS. 4B and 4C, bolt retainer clip 130 is inserted within bolt receiving element 122 prior to bolt 110 being received through bolt receiving element 122. As shown in FIGS. 4B and 4C, when bolt retainer clip 130 is inserted within bolt receiving element 122, bend 240 of bolt retainer clip 130 fits top edge 400 of bolt receiving element 122. For example, a shape or a configuration of bend 240 may match a shape or a configuration of top edge 400. Additionally, or alternatively, bend 240 may wrap around top edge 400.

As shown in FIGS. 4B and 4C, when bolt retainer clip 130 is inserted within bolt receiving element 122, bend 250 of bolt retainer clip 130 fits interior edge 420 of bolt receiving element 122. For example, a shape or a configuration of bend 250 may match a shape or a configuration of interior edge 420. Additionally, or alternatively, bend 250 may wrap around interior edge 420.

As shown in FIGS. 4B and 4C, component clip 134, of bolt retainer clip 130, is configured to be inserted within bolt receiving element 122 and clip onto first surface 124 of component 120 and second surface 430 of component 120. Second surface 430 may also be a surface of bolt receiving element 122. As shown in FIG. 4C, bolt engaging element 132 is configured to engage with bolt 110. As shown in FIG. 4C, when bolt 110 is inserted within bolt receiving element 122, a portion of component clip 134 is configured to be positioned between shoulder 114 of bolt 110 and inner surface 410 of bolt receiving element 122.

As shown in FIG. 4C, bend 230 may be configured to permit bolt engaging element 132 to slide along thread portion 112 of bolt 110 when component 120 is being attached to machine implement 100. For example, bend 230 may have sufficient flexibility to permit bolt engaging element 132 to slide along thread portion 112 of bolt 110 when component 120 is being attached to machine implement 100. As an example, bend 230 may move from a zero degree angle (or approximately zero degree angle) to a ninety degree angle or above (or approximately ninety degree angle or above) and return to a zero degree angle (or approximately zero degree angle). For instance, as shown in FIG. 4C, bend 230 may be configured to move from a first state to a second state when component 120 is being attached to machine implement 100 and to return to the first state after component 120 has been attached to machine implement 100. Additionally, or alternatively, bend 230 may be configured to extend when component 120 is being removed from machine implement 100 and to retract after component 120 has been removed from machine implement 100.

Additionally, or alternatively, bend 230 may be configured to extend when component 120 is being removed from machine implement 100 and to retract after component 120 has been removed from machine implement 100. Bend 230 may further be configured to permit bolt engaging element 132 to retain bolt 110 within bolt receiving element 122 when component 120 is being detached (or removed) from machine implement 100. For example, bend 230 may store sufficient potential energy to permit bolt engaging element 132 to retain bolt 110 within bolt receiving element 122 when component 120 is being detached from machine implement 100. Therefore, bolt engaging element 132 may be configured to engage with bolt 110 according to the potential energy stored by bend 230.

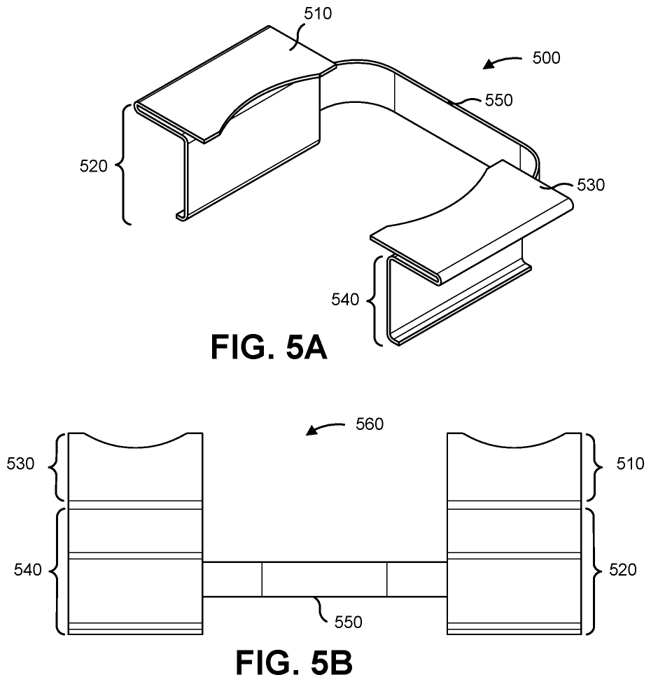

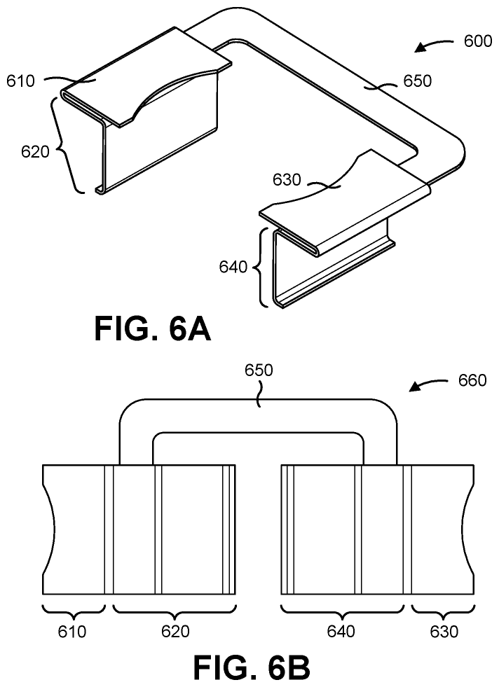

In some implementations, as will be described in more detailed below with respect to FIGS. 5 and 6, bolt 110 may be maintained within bolt receiving element 122 using an additional bolt engaging element and/or an additional component clip that may clip onto first surface 124 and surface 440 of component 120. While the disclosure herein is provided with respect to using bolt retainer clips 130 to retain or secure the position of bolt 110, the foregoing disclosure may be applicable to using bolt retainer clips 130 to retain or secure the positions of screws, pins, rivets, fasteners, and/or the like.

As indicated above, FIGS. 4A and 4B are provided as examples. Other examples may differ from what was described in connection with FIGS. 4A and 4B.

FIGS. 5A and 5B are diagrams of an example bolt retainer clip 500 that may be used with the bolts of FIG. 1. Some of the elements of bolt retainer clip 500 have been described above with respect to FIGS. 2 and 3A-3D. As shown in FIG. 5A, bolt retainer clip 500 includes a first bolt engaging element 510 and a first component clip 520 which have been described above with respect to FIGS. 2, 3A-3D, 4A, and 4B. Bolt retainer clip 500 further includes a second bolt engaging element 530 that is configured to engage with bolt 110 opposite first bolt engaging element 510.

As shown in FIG. 5A, bolt retainer clip 500 also includes a second component clip 540 that is configured to be inserted within bolt receiving element 122 opposite first component clip 520. Second component clip 540 is further configured to clip onto a third surface of component 120 and a fourth surface of component 120 that is also a surface of bolt receiving element 122. For example, second component clip 540 is further configured to clip onto first surface 124 and surface 440 of component 120. In some implementations, the third surface may be different than first surface 124.

As shown in FIG. 5A, bolt retainer clip 500 also includes a tether element 550 that is attached to first component clip 520 and second component clip 540. As shown in FIG. 5B, bolt retainer clip 500 may be formed using a single sheet of material 560, in a manner similar to the manner described above with respect to FIG. 2.

As indicated above, FIGS. 5A and 5B are provided as examples. Other examples may differ from what was described in connection with FIGS. 5A and 5B.

FIGS. 6A and 6B are diagrams of an example bolt retainer clip 600 that may be used with the bolts of FIG. 1. As shown in FIG. 6A, bolt retainer clip 600 includes a first bolt engaging element 610, a first component clip 620, a second bolt engaging element 630, a second component clip 640, and a tether element 650. These elements of bolt retainer clip 600 have been described above with respect to FIG. 5A. As shown in FIG. 6B, bolt retainer clip 600 may be formed using a single sheet of material 660, in a manner similar to the manner described above with respect to FIG. 2.

As indicated above, FIGS. 6A and 6B are provided as examples. Other examples may differ from what was described in connection with FIGS. 6A and 6B.

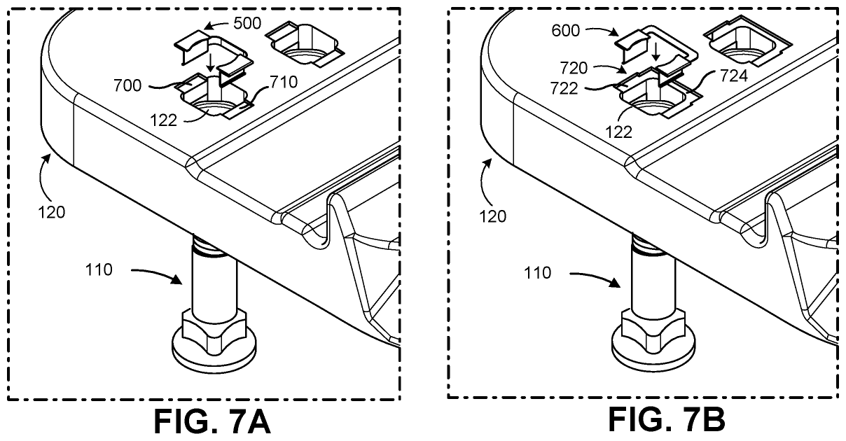

FIGS. 7A and 7B are diagrams of the bolt retainer clips of FIG. 5 and FIG. 6 being used with a component and a bolt of FIG. 1. As shown in FIG. 7A, bolt retainer clip 500 may be inserted within bolt receiving element 122 of component 120. In this regard, a first bolt retainer clip recess 700 of component 120 may receive first component clip 520 of bolt retainer clip 500. A second bolt retainer clip recess 710 of component 120 may receive second component clip 540 of bolt retainer clip 500.

As shown in FIG. 7B, component 120 includes bolt retainer clip recess 720. Bolt retainer clip recess 720 includes a first recess portion 722 and a second recess portion 724. As shown in FIG. 7B, bolt retainer clip 600 may be inserted within bolt receiving element 122 of component 120. In this regard, first recess portion 722 may be configured to receive first component clip 620 (e.g., a first portion of a component clip of bolt retainer clip 600). Second recess portion 724 may be configured to receive tethering element 650 of bolt retainer clip 600 (e.g., a second portion of a component clip of bolt retainer clip 600).

As indicated above, FIGS. 7A and 7B are provided as examples. Other examples may differ from what was described in connection with FIGS. 7A and 7B.

### INDUSTRIAL APPLICABILITY

The disclosed bolt retainer clip (e.g., bolt retainer clip 130) may be used with a bolt (e.g., bolt 110) in a component (e.g., component 120) to maintain the bolt within the component. The disclosed bolt retainer clip may be configured to be inserted within a bolt receiving element (e.g., bolt receiving element 122) of a component (e.g., component 120) prior to the bolt (e.g., bolt 110) being received by the bolt receiving element. The disclosed bolt retainer clip includes a bolt engaging element (e.g., bolt engaging element 132) that engages with a bolt. The disclosed bolt retainer clip also includes a component clip (e.g., component clip 134) that is inserted within the bolt receiving element of the component and that clips onto a first surface of the component and a second surface of the component that is also a surface of the bolt receiving element. The disclosed bolt retainer clip may maintain the bolt within the bolt receiving element prior to, during, and after installation and removal of the component.

Several advantages may be associated with the disclosed bolt retainer clip. For example, using the disclosed bolt retainer clip to retain a bolt (within a component to be installed on or removed from a machine implement) may decrease or eliminate the need to manually maintain and/or adjust the position of the bolt within the component during installation or removal. Thus, an installation process of the component on the machine implement and a removal process of the component from the machine implement may be improved. For example, the speed of the installation process and the removal process may be improved by decreasing or eliminating the need to manually maintain and/or adjust a position of the bolt within the component. Furthermore, using a bolt retainer clip to maintain the bolt within the component may improve the accuracy of the installation process and the removal process of the component. Additionally, using the disclosed bolt retainer clip to maintain the bolt within the component may reduce the amount of resources for the installation process and the removal process. For example, the number of workers, typically required for such installation process and removal process, may be reduced.

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations may be made in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

What is claimed is:

1. A bolt retainer clip to maintain a bolt within a bolt receiving element of a component, the bolt retainer clip comprising:
a component clip that is configured to:
be inserted within the bolt receiving element of the component, and
clip onto a first surface of the component and a second surface of the component that is also a surface of the bolt receiving element; and
a bolt engaging element that is configured to engage with the bolt.

2. The bolt retainer clip of claim 1, wherein the component clip and the bolt engaging element are formed from a same sheet of material.

3. The bolt retainer clip of claim 2, wherein the bolt engaging element is formed using a first portion of the sheet of material and the component clip is formed using a second portion of the sheet of material that is different than the first portion.

4. The bolt retainer clip of claim 3, wherein the first portion of the sheet of material includes a concave edge that has a circumference that corresponds to a circumference of a threaded portion of the bolt.

5. The bolt retainer clip of claim 2, wherein the sheet of material is bent to include:
a first portion that includes the bolt engaging element, and
a second portion that includes the component clip.

6. The bolt retainer clip of claim 5, wherein the second portion includes:
a first bend that fits a top edge that is between an inner surface of the bolt receiving element and the first surface of the component, and
a second bend that fits an interior edge that is between the inner surface of the bolt receiving element and the second surface of the component,
wherein the inner surface is between the first surface and the second surface.

7. The bolt retainer clip of claim 1, wherein the bolt engaging element is configured to engage with the bolt according to potential energy stored by a bend in a sheet of material between the component clip and the bolt engaging element.

8. The bolt retainer clip of claim 1, wherein the component clip is to be inserted within a bolt retainer clip recess of the component.

9. The bolt retainer clip of claim 1, wherein the component clip is a first component clip and the bolt engaging element is a first bolt engaging element, wherein the bolt retainer clip further comprises:
a second component clip that is configured to:
be inserted within the bolt receiving element opposite the first component clip, and
clip onto a third surface of the component and a fourth surface of the component that is also a surface of the bolt receiving element; and
a second bolt engaging element that is configured to engage with the bolt opposite the first bolt engaging element.

10. The bolt retainer clip of claim 9, further comprising:
a tether element that is attached to the first component clip and the second component clip.

11. A pre-installation assembly for mechanically attaching a component to a machine implement using a bolt, the pre-installation assembly comprising:
the component; and
a bolt retainer clip to retain the bolt within a bolt receiving element of the component,
wherein the bolt retainer clip comprises:
a component clip configured to be:
inserted within the bolt receiving element of the component, and
clipped onto a first surface of the component and a second surface of the component that is also a surface of the bolt receiving element; and
a bolt engaging element configured to engage with the bolt.

12. The pre-installation assembly of claim 11, wherein the bolt retainer clip is configured to be inserted within the bolt receiving element before the bolt.

13. The pre-installation assembly of claim 11, wherein, when the bolt is inserted within the bolt receiving element, a portion of the component clip is configured to be positioned between a shoulder of the bolt and an inner surface of the bolt receiving element.

14. The pre-installation assembly of claim 11, wherein the component clip and the bolt engaging element are formed from a same sheet of material, and
wherein a bend in the sheet of material, that is between the component clip and the bolt engaging element, is configured to:
permit the bolt engaging element to slide along a thread portion of the bolt when the component is being attached to the machine implement, and
permit the bolt engaging element to retain the bolt within the bolt receiving element when the component is being detached from the machine implement.

15. The pre-installation assembly of claim 11, wherein a width of the bolt engaging element is wider than a diameter of a thread portion of the bolt.

16. The pre-installation assembly of claim 11, wherein a width of the bolt engaging element is wider than a width of a portion of the component clip.

17. The pre-installation assembly of claim 11, wherein a width of a first portion of the component clip corresponds to a width of the bolt engaging element and a width of a second portion of the component clip corresponds to a width of the bolt receiving element.

18. The pre-installation assembly of claim 11, wherein the bolt retainer clip comprises a first bolt retainer clip, wherein the pre-installation assembly further comprises:
a second bolt retainer clip that is symmetrical to the first bolt retainer clip and configured to be inserted within the bolt receiving element opposite the first bolt retainer clip.

19. The pre-installation assembly of claim 18, wherein the first bolt retainer clip and the second bolt retainer clip are attached via a tether element.

20. A component configured to be attached to a machine implement via a bolt, the component comprising:
a bolt receiving element; and
a bolt retainer clip recess associated with the bolt receiving element,
wherein the bolt retainer clip recess includes:
a first recess portion that is configured to receive a first portion of a component clip, and
a second recess portion that is configured to receive a second portion of the component clip,
wherein the component clip is a portion of a bolt retainer clip that is configured to clip onto the component to permit a bolt engaging element of the bolt retainer clip to retain the bolt within the bolt receiving element.
